(19) United States
(12) Patent Application Publication
(10) Pub. No.: US 2020/0181473 A1
(43) Pub. Date: Jun. 11, 2020

(54) TREATMENT FLUIDS AND METHODS OF USE

(71) Applicant: Halliburton Energy Services, Inc., Houston, TX (US)

(72) Inventors: Chesnee Lae Davis, Spring, TX (US); Catherine Martin Santos, Houston, TX (US); Jeffrey James Miller, Spring, TX (US)

(21) Appl. No.: 16/591,022

(22) Filed: Oct. 2, 2019

Related U.S. Application Data
(60) Provisional application No. 62/776,030, filed on Dec. 6, 2018.

(51) Int. Cl. C09K 8/20

(52) U.S. Cl. CPC C09K 8/206

(57) ABSTRACT

Methods for using treatment fluids and additives that include xanthan gum and attapulgite. In one or more embodiments, the methods of the present disclosure include providing a treatment fluid comprising an aqueous base fluid, xanthan gum, and attapulgite; and introducing the treatment fluid into at least a portion of a subterranean formation.

### CROSS-REFERENCE TO RELATED APPLICATION

This application claims priority from U.S. Provisional Application Ser. No. 62/776,030, entitled “RISERLESS TREATMENT FLUIDS AND METHODS OF USE,” filed on Dec. 6, 2018, the entire disclosure of which is incorporated herein by reference.

### BACKGROUND

The present disclosure relates to compositions and methods for treating a subterranean formation.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like.

While drilling an oil or gas well, a drilling fluid (or drilling mud) is typically pumped down to a drill bit during drilling operations and flowed back to the surface through an annulus defined between a drill string and the walls of the well bore. Offshore hydrocarbon drilling operations are typically conducted from a drilling rig located either on a bottom-founded offshore platform or on a floating platform. In some instances, a steel tube, called a riser, is run to extend the borehole from the bottom of the sea to the rig. The riser serves, among other things, as a guide for the drill pipe into the hole and as a return path for the drilling fluid to the vessel. In other instances, the upper portion of the well is drilled by riserless drilling such that no conduit is provided to return the drilling fluid to the platform. In riserless drilling, the drilling fluid, cuttings, and well fluids are discharged onto the seafloor and are not conveyed to the surface. To drill the initial upper portion of the well, the drill string typically extends unsupported through the water to the seafloor without a riser. When performing riserless drilling, the drilling fluid often includes, for example, polymers, hydrating clays, and salts to improve inhibition, density, viscosity, and other rheological properties of the drilling fluid.

### BRIEF DESCRIPTION OF THE DRAWINGS

These drawings illustrate certain aspects of some of the embodiments of the present disclosure and should not be used to limit or define the claims.

FIG. 1 is a diagram illustrating an example of an offshore drilling system that may be used in accordance with certain embodiments of the present disclosure.

FIG. 2 is a diagram illustrating an example of an offshore drilling system that may be used in accordance with certain embodiments of the present disclosure.

FIG. 3 is graph representing rheological and fluid loss data for treatment fluids in accordance with certain embodiments of the present disclosure.

FIG. 4 is graph representing rheological data for treatment fluids in accordance with certain embodiments of the present disclosure.

FIGS. 5A, 5B, 5C, and 5D are a series of photographs illustrating storage of treatment fluids in accordance with certain embodiments of the present disclosure.

FIG. 6 is a graph representing stability data for treatment fluids in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those of ordinary skill in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to compositions and methods for treating a subterranean formation. More particularly, the present disclosure relates to subterranean treatment fluids including an additive that includes xanthan gum and attapulgite and methods for using such treatment fluids to treat subterranean formations.

The present disclosure provides compositions including an aqueous base fluid, xanthan gum, and attapulgite. In certain embodiments, the methods of the present disclosure include providing a treatment fluid including an aqueous base fluid, xanthan gum, and attapulgite, and introducing the treatment fluid into at least a portion of a subterranean formation. In certain embodiments, the methods of the present disclosure include drilling at least a portion of a well bore to penetrate at least a portion of a subterranean formation, and circulating a drilling fluid including an aqueous base fluid, xanthan gum, and attapulgite in at least the portion of the well bore while drilling. In certain embodiments, the compositions of the present disclosure may further include a filtration control agent.

Among the many potential advantages to the methods and compositions of the present disclosure, only some of which are alluded to herein, the compositions and methods of the present disclosure may, inter alia, aid in viscosifying a treatment fluid, suspending particulates (e.g., drilling cuttings) in a treatment fluid, and/or reducing fluid loss. In certain embodiments, the compositions and methods of the present disclosure may exhibit, for example, fragile gel and tau zero properties similar to treatment fluids including xanthan gum alone, which may result in a significant cost reduction while maintaining desired fluid properties.

Those of ordinary skill in the art having the benefit of the present disclosure will appreciate the types of treatment fluids including a base fluid and an additive of the present disclosure that may be used in accordance with the methods of the present disclosure. Examples of such treatment fluids include, but are not limited to, drill-in fluids, drilling fluids, completion fluids, workover fluids, fracturing fluids, and the like. In certain embodiments, the treatment fluids of the present disclosure may include any base fluid known in the art, including aqueous base fluids, non-aqueous base fluids, and any combinations thereof. The term “base fluid” refers to the major component of the fluid (as opposed to components dissolved and/or suspended therein) and does not indicate any particular condition or property of that fluids such as its mass, amount, pH, etc.

Aqueous base fluids that may be suitable for use in the methods of the present disclosure may include water from any source. Such aqueous base fluids may include fresh water, salt water (e.g., water containing one or more salts dissolved therein), brine (e.g., saturated salt water), seawater, or any combination thereof. In some embodiments, the aqueous base fluids may include one or more ionic species, such as those formed by salts dissolved in water. For example, seawater and/or produced water may include a variety of divalent cationic species dissolved therein. The ionic species may be any suitable ionic species known in the art. In certain embodiments, the ionic species may be one or more salts selected from the group consisting of: sodium chloride, sodium bromide, sodium acetate, potassium acetate, sodium formate, sodium citrate, potassium chloride, potassium formate, calcium chloride, calcium nitrate, calcium bromide, magnesium chloride, magnesium bromide, magnesium sulfate, cesium formate, and any combination thereof.

In certain embodiments, one or more salts may be present in the aqueous base fluid in an amount within a range from about 50 mg/L of aqueous base fluid to about 500,000 mg/L of aqueous base fluid. In other embodiments, the salts may be present in the aqueous base fluid in an amount within a range from about 100 mg/L of aqueous base fluid to about 200,000 mg/L of aqueous base fluid. In other embodiments, the salts may be present in the aqueous base fluid in an amount within a range from about 200 mg/L of aqueous base fluid to about 100,000 mg/L of aqueous base fluid. In certain embodiments, the aqueous base fluid may be saturated with one or more salts. In other embodiments, the aqueous base fluid may be supersaturated with one or more salts. In certain embodiments, the density of the aqueous base fluid can be adjusted to, among other purposes, provide additional particulate transport and suspension. In certain embodiments, the pH of the aqueous base fluid may be adjusted (e.g., by a buffer or other pH adjusting agent) to a specific level, which may depend on, among other factors, the types of clays, acids, and other additives included in the fluid. One of ordinary skill in the art with the benefit of this disclosure will recognize when such density and/or pH adjustments are appropriate.

In certain embodiments, the treatment fluids of the present disclosure may include xanthan gum and attapulgite. These components may, for example, increase the viscosity, suspension, and/or filtration control of a fluid. In certain embodiments, the xanthan gum and attapulgite may be provided as an additive that includes the xanthan gum and the attapulgite, either alone or in combination with other components. In certain embodiments, the additive may be included in an amount of from about 0.1 pounds per barrel (“lb/bbl”) of the treatment fluid to about 20 lb/bbl of the treatment fluid. In other embodiments, the additive may be included in an amount of from about 1 lb/bbl of the treatment fluid to about 15 lb/bbl of the treatment fluid. In other embodiments, the additive may be included in an amount of from about 2 lb/bbl of the treatment fluid to about 10 lb/bbl of the treatment fluid. In other embodiments, the additive may be included in an amount of from about 0.5 lb/bbl of the treatment fluid to about 5 lb/bbl of the treatment fluid. In other embodiments, the additive may be included in an amount of from about 1 lb/bbl of the treatment fluid to about 8 lb/bbl of the treatment fluid.

In certain embodiments, one or more of the components of the additive (e.g., xanthan gum and attapulgite) may be combined before being added to the treatment fluid. In other embodiments, one or more of the components of the additive (e.g., xanthan gum and attapulgite) may be added to the treatment fluid individually. In either case, the components are considered an additive for the purposes of this disclosure.

In certain embodiments, the xanthan gum and attapulgite may be provided or present in the treatment fluids and/or additives of the present disclosure in amounts having ratios of from about 1:1 to about 1:10. In other embodiments, the xanthan gum and attapulgite may be provided or present in the treatment fluids and/or additives of the present disclosure may include a ratio of xanthan gum and attapulgite from about 1:1 to about 1:5 In other embodiments, the xanthan gum and attapulgite may be provided or present in the treatment fluids and/or additives of the present disclosure may include a ratio of xanthan gum and attapulgite from about 1:1 to about 1:2.

In certain embodiments, the xanthan gum may be provided or present in the treatment fluids of the present disclosure in an amount from about 0.1 lb/bbl of the treatment fluid to about 10 lb/bbl of the treatment fluid. In other embodiments, the xanthan gum may be provided or present in the treatment fluids of the present disclosure in an amount from about 0.1 lb/bbl of the treatment fluid to about 5 lb/bbl of the treatment fluid. In other embodiments, the xanthan gum may be provided or present in the treatment fluids of the present disclosure in an amount from about 0.1 lb/bbl of the treatment fluid to about 2 lb/bbl of the treatment fluid.

In certain embodiments, the attapulgite may be provided or present in the treatment fluids of the present disclosure in an amount from about 0.1 lb/bbl of the treatment fluid to about 20 lb/bbl of the treatment fluid. In other embodiments, the provided or attapulgite may be present in the treatment fluids of the present disclosure in an amount from about 1 lb/bbl of the treatment fluid to about 20 lb/bbl of the treatment fluid. In other embodiments, the attapulgite may be provided or present in the treatment fluids of the present disclosure in an amount from about 1.5 lb/bbl of the treatment fluid to about 14 lb/bbl of the treatment fluid. In other embodiments, the attapulgite may be provided or present in the treatment fluids of the present disclosure in an amount from about 2 lb/bbl of the treatment fluid to about 8 lb/bbl of the treatment fluid.

In certain embodiments, the treatment fluids of the present disclosure may include one or more filtration control agents. In certain embodiments, the filtration control agents may include, but are not limited to, starch, cellulose, synthetic polymers, nanomaterial forms of the foregoing, any derivative thereof, and any combination thereof. In certain embodiments, the filtration control agent may be provided or present in the treatment fluids of the present disclosure in an amount from about 0.1 lb/bbl of the treatment fluid to about 15 lb/bbl of the treatment fluid. In other embodiments, the filtration control agent may be provided or present in the treatment fluids of the present disclosure in an amount from about 0.5 lb/bbl of the treatment fluid to about 10 lb/bbl of the treatment fluid. In other embodiments, the filtration control agent may be provided or present in the treatment fluids of the present disclosure in an amount from about 0.75 lb/bbl of the treatment fluid to about 5 lb/bbl of the treatment fluid.

In certain embodiments, the treatment fluids of the present disclosure may include one or more weighting agents. In certain embodiments, weighting agents may include, but are not limited to, barite, iron oxides such as hematite, galena, calcium carbonate (calcite), siderite, any other solid material which is capable of weighting a treatment fluid, and any combination thereof. In certain embodiments, the weighting agent may be provided or present in the treatment fluid in an amount from about 50 lb/bbl of the treatment fluid to about 600 lb/bbl of the treatment fluid. In other embodiments, the weighting agent may be provided or present in the treatment fluid in an amount from about 300 lb/bbl of the treatment fluid to about 500 lb/bbl of the treatment fluid. In other embodiments, the weighting agent may be provided or present in the treatment fluid in an amount from about 275 lb/bbl of the treatment fluid to about 450 lb/bbl of the treatment fluid.

In certain embodiments, the treatment fluids of the present disclosure may include any number of additives. Examples of such additives include, but are not limited to, salts, surfactants, acids, diverting agents, fluid loss control additives, gas, nitrogen, carbon dioxide, surface modifying agents, tackifying agents, foamers, corrosion inhibitors, scale inhibitors, catalysts, clay stabilizers, shale inhibitors, biocides, friction reducers, antifoam agents, additional bridging agents, flocculants, H₂S scavengers, CO₂ scavengers, oxygen scavengers, lubricants, hydrocarbons, additional viscosifying/gelling agents, breakers, weighting agents, relative permeability modifiers, resins, wetting agents, coating enhancement agents, filter cake removal agents, antifreeze agents (e.g., ethylene glycol), particulates, and the like. A person skilled in the art, with the benefit of this disclosure, will recognize the types of additives that may be included in the treatment fluids of the present disclosure for a particular application. In certain embodiments, the treatment fluids used in the methods of the present disclosure may have been used to treat a subterranean formation (e.g., as a drilling fluid or drill-in fluid). Thus, the treatment fluids may also include solids from the subterranean formation, for example, rock fragments generated by the drill bit during drilling.

In one or more embodiments, the methods of the present disclosure may include preparing a treatment fluid that includes an aqueous base fluid, xanthan gum, and attapulgite. In certain embodiments, the treatment fluids of the present disclosure may be saturated or supersaturated. In certain embodiments, the saturated or supersaturated treatment fluids of the present disclosure may have a density of about 15 ppg or above. In some embodiments, the saturated or supersaturated treatment fluids of the present disclosure may have a density from about 15 pounds per gallon (“ppg”) to about 18 ppg. In other embodiments, the saturated or supersaturated treatment fluids of the present disclosure may have a density from about 15 ppg to about 17 ppg. In other embodiments, the saturated or supersaturated treatment fluids of the present disclosure may have a density from about 15 ppg to about 16.3 ppg.

In one or more embodiments, the saturated or supersaturated treatment fluids of the present disclosure may be storable and/or stored for an extended period of time with minimal stratification or separation. In certain embodiments, the saturated or supersaturated treatment fluids of the present disclosure may be storable and/or stored for up to about 6 months with minimal stratification or separation. In certain embodiments, the saturated or supersaturated treatment fluids of the present disclosure may be storable and/or stored for up to about 12 weeks with minimal stratification or separation.

In one or more embodiments, the saturated or supersaturated treatment fluids of the present disclosure may be cut or diluted to reduce their density before being introduced into at least a portion of a subterranean formation. In certain embodiments, the treatment fluids may be cut or diluted using an aqueous fluid having a density lower than the treatment fluids (e.g., seawater). In certain embodiments, the ability to cut or dilute the density of a saturated or supersaturated treatment fluid may allow for dynamic, real-time control of the density of the treatment fluid while treating the subterranean formation (e.g., while drilling) in response to various parameters, such as the pressure of the subterranean formation.

In certain embodiments, the treatment fluids of the present disclosure when cut or diluted may have a density below about 15 ppg. In some embodiments, the treatment fluids of the present disclosure when cut or diluted may have a density from about 9 ppg to about 15 ppg. In other embodiments, the treatment fluids of the present disclosure when cut or diluted may have a density from about 9 ppg to about 13.5 ppg. In other embodiments, the treatment fluids of the present disclosure when cut or diluted may have a density from about 10 ppg to about 13.5 ppg.

In one or more embodiments, the components of the treatment fluid and/or additive, either combined or separately, may be added to the aqueous base fluid along with any other additives at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the treatment fluids of the present disclosure may be prepared, either in whole or in part, at an offsite location and transported to the site where the treatment or operation is conducted. In introducing a treatment fluid into a portion of a subterranean formation, the components of the treatment fluid may be mixed together at the surface and introduced into the formation together, or one or more components may be introduced into the formation at the surface separately from other components such that the components mix or intermingle in a portion of the formation to form a treatment fluid. In either such case, the treatment fluid is deemed to be introduced into at least a portion of the subterranean formation for purposes of the present disclosure.

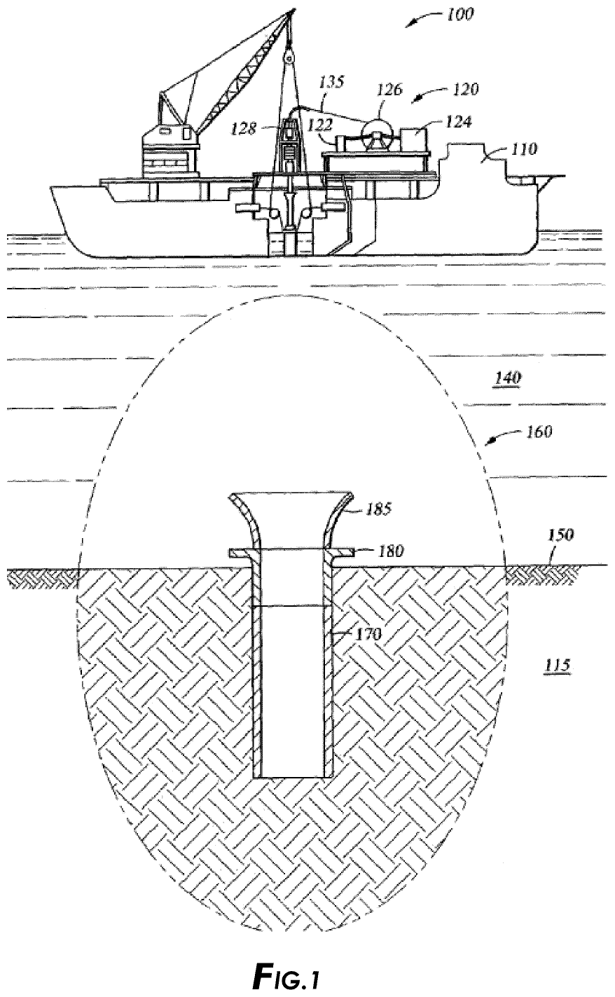

Some embodiments of the present disclosure provide methods for using the disclosed treatment fluids to carry out a variety of subterranean treatments, including but not limited to, drilling. The drilling fluids disclosed herein may directly or indirectly affect one or more components or pieces of equipment associated with the preparation, delivery, recapture, recycling, reuse, and/or disposal of the drilling fluids. For example, and with reference to FIG. 1, the drilling fluids disclosed herein may directly or indirectly affect one or more components or pieces of equipment associated with a well bore drilling assembly 100, according to one or more embodiments.

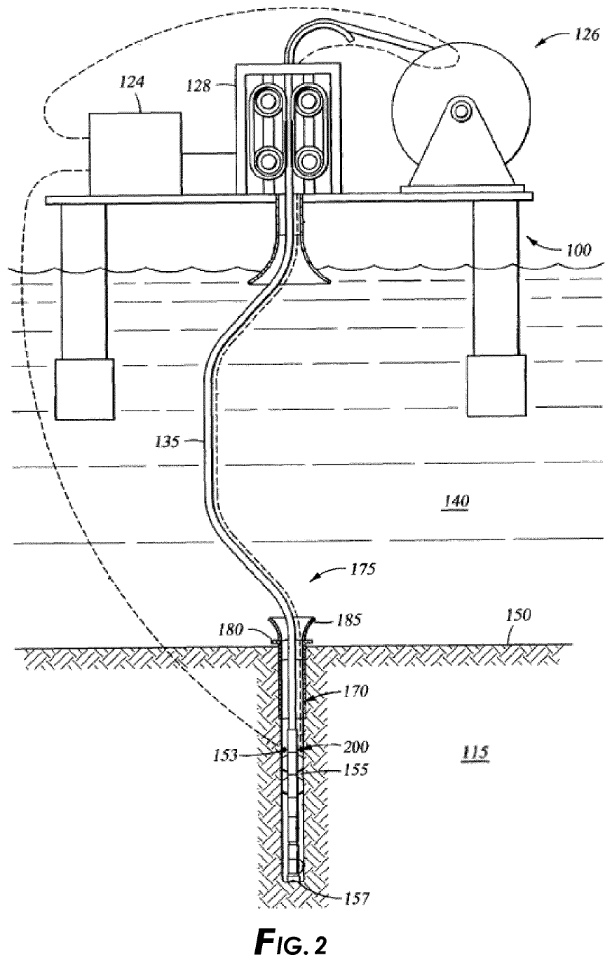

FIG. 1 depicts a schematic elevational view of one exemplary operating environment for certain embodiments of the present disclosure in an offshore riserless drilling operation. The offshore floating platform 100 is shown situated adjacent a subsea wellsite 160 in which structural casing 170, a low-pressure wellhead housing 180, and a bellmouth 185 have previously been installed. The offshore platform 100 comprises a floating vessel 110 and a drill string system 120 having a power supply 122, a surface processor 124, and a drill string spool 126. A drilling system 175, best shown in FIG. 2, includes a drill string 135 and a bottom hole assembly 200 for drilling a borehole 155 through a subsea subterranean formation 115. Although the drill string 135 is depicted as a light weight drill string, a heavy drill string could also be used in the methods of the present disclosure. An injector 128 on the offshore floating platform 100 advances the drill string 135 from the spool 126 through the water 140 towards the seafloor 150, or retracts the drill string 135 from the water 140 to be reeled back onto the spool 126, or holds the drill string 135 stationary. Further, the injector 128 applies to the drill string 135 the forces necessary for these operations.

A pump (e.g., not shown) circulates a drilling fluid of the present disclosure downhole through the interior of the drill string 135 and through one or more orifices in a drill bit 157 located at the end of the drill string 135. The drilling fluid may then be circulated back to the seabed 150 via an annulus defined between the drill string 135 and the borehole walls 153. In riserless drilling operations, no conduit is provided to return the drilling fluid to the offshore floating platform 100. Thus, after exiting the borehole 155, the recirculated or spent drilling fluid may remain at the seabed 150 or mix with the water 140. It should be noted that while FIG. 1 generally depicts an offshore riserless drilling operation, those skilled in the art will readily recognize that the principles described herein are equally applicable to offshore drilling operations that utilize risers as well as land-based drilling operations, without departing from the scope of the disclosure.

The drilling fluid of the present disclosure may directly or indirectly affect any pumps, conduits, pipelines, trucks, tubulars, and/or pipes used to fluidically convey the drilling fluid downhole, any pumps, compressors, or motors (e.g., topside or downhole) used to drive the drilling fluid into motion, any valves or related joints used to regulate the pressure or flow rate of the drilling fluid, and any sensors (e.g., pressure, temperature, flow rate, etc.), gauges, and/or combinations thereof, and the like.

The drilling fluid 122 of the present disclosure may also directly or indirectly affect the various downhole equipment and tools that may come into contact with the drilling fluid such as, but not limited to, the drill string 135, any floats, drill collars, mud motors, downhole motors and/or pumps associated with the drill string 135, and any MWD/LWD tools and related telemetry equipment, sensors or distributed sensors associated with the drill string 135. The disclosed drilling fluid 135 may also directly or indirectly affect any downhole heat exchangers, valves and corresponding actuation devices, tool seals, packers and other well bore isolation devices or components, and the like associated with the borehole 155. The disclosed drilling fluid may also directly or indirectly affect the drill bit 157, which may include, but is not limited to, roller cone bits, PDC bits, natural diamond bits, any hole openers, reamers, coring bits, etc.

While not specifically illustrated herein, the drilling fluid of the present disclosure may also directly or indirectly affect any transport or delivery equipment used to convey the drilling fluid to the offshore floating platform such as, for example, any transport vessels, conduits, pipelines, trucks, tubulars, and/or pipes used to fluidically move the drilling fluid from one location to another, any pumps, compressors, or motors used to drive the drilling fluid into motion, any valves or related joints used to regulate the pressure or flow rate of the drilling fluid, and any sensors (e.g., pressure and temperature), gauges, and/or combinations thereof, and the like.

An embodiment of the present disclosure is a method including: providing a treatment fluid comprising an aqueous base fluid, xanthan gum, and attapulgite; and introducing the treatment fluid into at least a portion of a subterranean formation.

In one or more embodiments described in the preceding paragraph, the subterranean formation is a subsea formation. In one or more embodiments described in the preceding paragraph, the xanthan gum and the attapulgite are provided or present in the treatment fluid in amounts having a ratio from about 1:1 to about 1:10. In one or more embodiments described in the preceding paragraph, the treatment fluid comprises the xanthan gum in an amount from about 0.1 lb/bbl of the treatment fluid to about 10 lb/bbl of the treatment fluid. In one or more embodiments described in the preceding paragraph, the treatment fluid comprises the attapulgite in an amount from about 0.2 lb/bbl of the treatment fluid to about 20 lb/bbl of the treatment fluid. In one or more embodiments described in the preceding paragraph, the treatment fluid further comprises one or more additional additives selected from the group consisting of: a filtration control agent; a weighting agent; and any combination thereof. In one or more embodiments described in the preceding paragraph, the treatment fluid has a density above about 15 ppg, and wherein the method further comprises reducing the density of the treatment fluid to below about 15 ppg before introducing the treatment fluid into the subterranean formation. In one or more embodiments described in the preceding paragraph, the treatment fluid has a first tau zero value that is substantially similar to a second tau zero value of a second treatment fluid not comprising attapulgite but otherwise having the same composition as the treatment fluid.

An embodiment of the present disclosure is a method including: drilling at least a portion of a well bore to penetrate at least a portion of a subterranean formation; and circulating a drilling fluid comprising an aqueous base fluid, xanthan gum, and attapulgite in at least the portion of the well bore while drilling.

In one or more embodiments described in the preceding paragraph, the subterranean formation is a subsea formation. In one or more embodiments described in the preceding paragraph, drilling the portion of the well bore to penetrate the portion of the subterranean formation is performed without a riser. In one or more embodiments described in the preceding paragraph, the xanthan gum and the attapulgite are provided or present in the treatment fluid in amounts having a ratio from about 1:1 to about 1:10. In one or more embodiments described in the preceding paragraph, the drilling fluid comprises the xanthan gum in an amount from about 0.1 lb/bbl of the drilling fluid to about 10 lb/bbl of the drilling fluid. In one or more embodiments described in the preceding paragraph, the drilling fluid comprises the attapulgite in an amount from about 0.2 lb/bbl of the drilling fluid to about 20 lb/bbl of the drilling fluid. In one or more embodiments described in the preceding paragraph, the drilling fluid has a density above about 15 ppg, and the method further comprises reducing the density of the drilling fluid to below about 15 ppg before circulating the drilling fluid in at least the portion of the well bore.

An embodiment of the present disclosure is a method including: providing a treatment fluid comprising an aqueous base fluid, xanthan gum, and attapulgite, wherein the treatment fluid has a density above about 15 ppg; reducing the density of the treatment fluid to below about 15 ppg; and introducing the treatment fluid into at least a portion of a subterranean formation.

In one or more embodiments described in the preceding paragraph, the subterranean formation is a subsea formation. In one or more embodiments described in the preceding paragraph, drilling at least a portion of a well bore to penetrate at least a portion of a subterranean formation. In one or more embodiments described in the preceding paragraph, the treatment fluid comprises the xanthan gum in an amount from about 0.1 lb/bbl of the treatment fluid to about 10 lb/bbl of the treatment fluid. In one or more embodiments described in the preceding paragraph, the treatment fluid comprises the attapulgite in an amount from about 0.2 lb/bbl of the treatment fluid to about 20 lb/bbl of the treatment fluid.

### EXAMPLES

To facilitate a better understanding of the present disclosure, the following example of certain aspects of certain embodiments are given. The following example is not the only example that could be given according to the present disclosure and are not intended to limit the scope of the disclosure or claims.

### Example 1

Two treatment fluids of the present disclosure including xanthan gum and attapulgite (Formulations B and C) were prepared according to the Table 1 below along with an existing formulation including only xanthan gum (Formulation A).

TABLE 1

| Component | Formulation A | Formulation B | Formulation C |
|---|---|---|---|
| 10 ppg NaCl Brine, | 0.656 | 0.656 | 0.656 |
| bbl | | | |
| NaCl, lb/bbl | 110 | 110 | 110 |
| Seawater, bbl | — | — | — |
| Filtration Control | — | 1 | — |
| Agent, lb/bbl | | | |
| Xanthan Gum, lb/bbl | 2 | 1 | 1 |
| Attapulgite, lb/bbl | — | 2 | 2 |
| Weighting Agent, | 303 | 303 | 303 |
| lb/bbl | | | |

After mixing, each treatment fluid has density of about 16.3 ppg. The density of each treatment fluid was reduced to about 12.5 ppg by adding seawater. The yield point, tau zero, and fluid loss were then measured in accordance with API 13A, Specifications for Drilling Fluid Materials, at room temperature for each treatment fluid. As used herein, the “tau zero” parameter refers to the fluid's yield stress at zero shear rate (0 rpm). As shown in FIG. 3, the tau zero and fluid loss were the same as for Formulation B of the present disclosure and the existing Formulation A. Thus, this Example demonstrates that the formulations of the present disclosure including xanthan gum and attapulgite exhibits comparable suspension and fluid loss properties a formulation comprising only xanthan gum. Therefore, in certain embodiments, the treatment fluids of the present disclosure that include xanthan gum and attapulgite may exhibit a tau zero value that is substantially similar to a treatment fluid without attapulgite while also exhibiting a lower yield point. As used herein, the term “substantially similar” refers to a difference of equal to or less than about 1%, alternatively about 2.5%, alternatively about 5%, alternatively about 10%, alternatively about 20%.

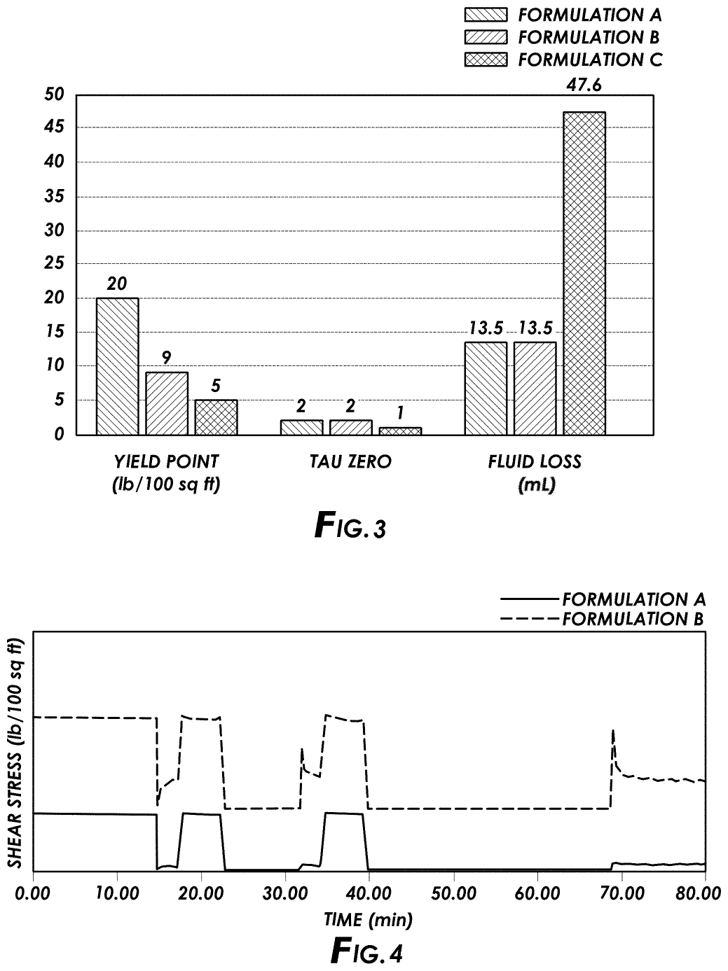

The low shear gel strength was also measured according to API 13B-1 for each treatment fluid over 80 minutes. A shear rate of 100 rpm was applied between measurements of gel strength. FIG. 4 shows the suspension capabilities of a treatment fluid having Formulation B of the present disclosure, as indicated by the quick spike at the 70-minute mark, as compared to the suspension capabilities of a treatment fluid having comparative Formulation A. FIG. 4 also shows that the gel formed by the treatment fluid having Formulation B of the present disclosure is easily breakable (e.g., the treatment fluid quickly becomes pumpable) as indicated by the L-shaped curve after the gel is broken.

### Example 2

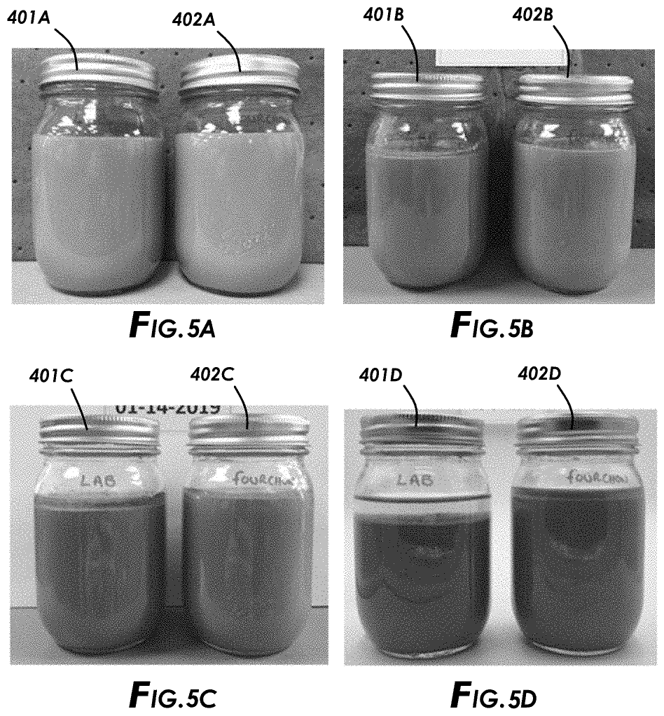

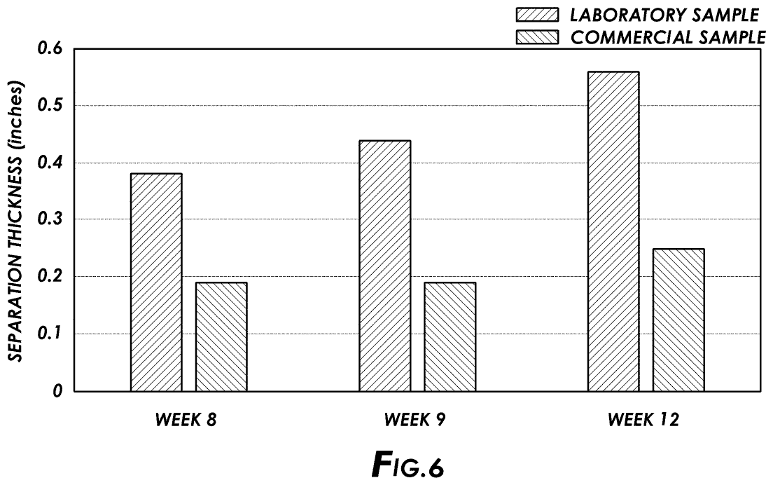

To assess the storage stability, laboratory-scale and commercial-scale treatment fluids having Formulation B from Example 1 were prepared. As shown in FIG. 5A, a 350 mL sample from the laboratory-scale treatment fluid (401A) and a 350 mL sample from the commercial-scale treatment fluid (402A) were placed in glass jars in the laboratory and observed on a weekly basis for twelve weeks. FIGS. 5B, 5C, and 5D show the samples at two weeks, five weeks, and twelve weeks, respectively. As shown in FIG. 5B, slight water separation was observed at the surface in the laboratory sample (401B) at two weeks. This likely indicates a reduction in the fluid's stability, which could require remixing and/or treatment of the fluid before use to achieve the benefits disclosed herein. As shown in FIG. 5C, by five weeks, the commercial sample (402C) first started to show water separation while the laboratory sample (401C) had a progressively thicker band of water separation. As shown in FIG. 5D, the band of water separation continued to thicken in both the laboratory sample (401D) and the commercial sample (402D) through the reminder of the twelve weeks. However, the separation was not substantial. FIG. 6 likewise shows that the water separation thickness increased for both the laboratory sample and the commercial sample from eight to twelve weeks.

Thus, Example 2 demonstrates that the treatment fluids of the present disclosure may be prepared several weeks before use and stored without significant deterioration. This may be particularly useful if changes in operational schedules at a wellsite occur. Additionally, if a portion of a batch of treatment fluid is not used in a single operation, the remaining treatment fluid could be returned to shore and stored for later use.

### Example 3

The commercial-scale treatment fluid from Example 2 was tested to evaluate the stability of certain properties over time. The density of treatment fluid was reduced from about 16.3 ppg to about 12.5 ppg by adding seawater. As shown below in Table 2, the measured properties of the treatment fluid remained unchanged after 14 days. Thus, Example 3 demonstrates that certain properties of the treatment fluid remain unaffected for at least 14 days.

TABLE 2

| Rheology | Day 1 | Day 14 |
|---|---|---|
| 600 | 42 | 42 |
| 300 | 29 | 29 |
| 200 | 22 | 22 |
| 100 | 15 | 15 |
| 6 | 6 | 6 |
| 3 | 4 | 4 |
| 10 sec | 6 | 6 |
| 10 min | 8 | 8 |
| PV | 13 | 13 |
| YP | 16 | 16 |
| API | 16.8 | 16.8 |

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid comprising an aqueous base fluid, xanthan gum, and attapulgite; and
introducing the treatment fluid into at least a portion of a subterranean formation.

2. The method of claim 1, wherein the subterranean formation is a subsea formation.

3. The method of claim 1, wherein the xanthan gum and the attapulgite are provided or present in the treatment fluid in amounts having a ratio from about 1:1 to about 1:10.

4. The method of claim 1, wherein the treatment fluid comprises the xanthan gum in an amount from about 0.1 lb/bbl of the treatment fluid to about 10 lb/bbl of the treatment fluid.

5. The method of claim 1, wherein the treatment fluid comprises the attapulgite in an amount from about 0.2 lb/bbl of the treatment fluid to about 20 lb/bbl of the treatment fluid.

6. The method of claim 1, wherein the treatment fluid further comprises one or more additional additives selected from the group consisting of: a filtration control agent; a weighting agent; and any combination thereof.

7. The method of claim 1, wherein the treatment fluid has a density above about 15 ppg, and wherein the method further comprises reducing the density of the treatment fluid to below about 15 ppg before introducing the treatment fluid into the subterranean formation.

8. The method of claim 1, wherein the treatment fluid has a first tau zero value that is substantially similar to a second tau zero value of a second treatment fluid not comprising attapulgite but otherwise having the same composition as the treatment fluid.

9. A method comprising:
drilling at least a portion of a well bore to penetrate at least a portion of a subterranean formation; and
circulating a drilling fluid comprising an aqueous base fluid, xanthan gum, and attapulgite in at least the portion of the well bore while drilling.

10. The method of claim 9, wherein the subterranean formation is a subsea formation.

11. The method of claim 10, wherein drilling the portion of the well bore to penetrate the portion of the subterranean formation is performed without a riser.

12. The method of claim 9, wherein the xanthan gum and the attapulgite are provided or present in the treatment fluid in amounts having a ratio from about 1:1 to about 1:10.

13. The method of claim 9, wherein the drilling fluid comprises the xanthan gum in an amount from about 0.1 lb/bbl of the drilling fluid to about 10 lb/bbl of the drilling fluid.

14. The method of claim 9, wherein the drilling fluid comprises the attapulgite in an amount from about 0.2 lb/bbl of the drilling fluid to about 20 lb/bbl of the drilling fluid.

15. The method of claim 9, wherein the drilling fluid has a density above about 15 ppg, and wherein the method further comprises reducing the density of the drilling fluid to below about 15 ppg before circulating the drilling fluid in at least the portion of the well bore.

16. A method comprising:
providing a treatment fluid comprising an aqueous base fluid, xanthan gum, and attapulgite, wherein the treatment fluid has a density above about 15 ppg;
reducing the density of the treatment fluid to below about 15 ppg; and
introducing the treatment fluid into at least a portion of a subterranean formation.

17. The method of claim 16, wherein the subterranean formation is a subsea formation.

18. The method of claim 16 further comprising drilling at least a portion of a well bore to penetrate at least a portion of a subterranean formation.

19. The method of claim 16, wherein the treatment fluid comprises the xanthan gum in an amount from about 0.1 lb/bbl of the treatment fluid to about 10 lb/bbl of the treatment fluid.

20. The method of claim 16, wherein the treatment fluid comprises the attapulgite in an amount from about 0.2 lb/bbl of the treatment fluid to about 20 lb/bbl of the treatment fluid.
